(19) United States
(12) Patent Application Publication
(10) Pub. No.: US 2021/0402952 A1
(43) Pub. Date: Dec. 30, 2021

(54) AIRBAG DEVICE, CONTROL METHOD OF AIRBAG DEVICE, AND CONTROL SYSTEM OF AIRBAG DEVICE

(71) Applicant: HONDA MOTOR CO., LTD., Tokyo (JP)

(72) Inventors: Hidetoshi Nakamura, Wako-shi (JP); Hyejin Bae, Wako-shi (JP); Kenyu Okamura, Tokyo (JP); Osamu Ito, Wako-shi (JP); Hiroyuki Asanuma, Wako-shi (JP); Hiromi Koshiki, Echi-gun (JP); Kei Tsujimoto, Echi-gun (JP); Shoichi Sawa, Echi-gun (JP)

(21) Appl. No.: 17/355,239

(22) Filed: Jun. 23, 2021

(30) Foreign Application Priority Data
Jun. 26, 2020 (JP) 2020-110351

(51) Int. Cl. B60R 21/36; B60R 21/0134

(52) U.S. Cl. CPC B60R 21/36; B60R 2021/01013; B60R 21/0134

(57) ABSTRACT

An airbag device includes a first chamber filled with a gas supplied from a first gas supply part and inflated and deployed in a traveling direction of a vehicle body, a second chamber that is disposed behind the first chamber and able to bring in communication with an inside of the first chamber through a communication section, and a third chamber disposed to cover the communication section and configured to adjust an opening degree of the communication section by being filled with a gas supplied from a second gas supply part and being inflated and deployed.

### CROSS-REFERENCE TO RELATED APPLICATION

Priority is claimed on Japanese Patent Application No. 2020-110351, filed Jun. 26, 2020, the content of which is incorporated herein by reference.

### BACKGROUND OF THE INVENTION

### Field of the Invention

The present invention relates to an airbag device, a control method of the airbag device, and a control system of the airbag device.

### Description of Related Art

In the related art, airbag devices having bag bodies inflated and deployed to restraint a target person such as an occupant, a pedestrian, or the like upon an impact input are mounted in a vehicle body. In these airbag devices, various technologies for restraining the target person more stably have been proposed.

For example, an airbag device disclosed in Japanese Translation of PCT International Application Publication No. JP 2004-535967 is divided into a main chamber and a second chamber by seams which is broken by a predetermined maximum inflation pressure. The plurality of seams are formed stepwise from a central section filled with a gas to an outward side in a radial direction. In addition, the seams are made of a thread that is easily broken. For this reason, in the airbag disclosed in Japanese Translation of PCT International Application Publication No. JP 2004-535967, when the central section of the main chamber is filled with a gas and an inflation pressure in the central section increases, breakage starts from the seam near the central section, and a gas fills toward the outside of the main chamber. Accordingly, in the airbag disclosed in Japanese Translation of PCT International Application Publication No. JP 2004-535967, deploying behaviors of the plurality of chambers can be controlled, and energy transmitted to a target person can be reduced.

### SUMMARY OF THE INVENTION

Incidentally, in the technical field of airbag devices, in order to restraint a target person, it is desired to accurately control deploying behaviors of a plurality of chambers.

An aspect of the present invention is directed to providing an airbag device, a control method of the airbag device, and a control system of the airbag device that are configured to control a deploying behavior of an airbag having a plurality of chambers and restraint a target person.

(1) An airbag device according to an aspect of the present invention includes a first chamber filled with a gas supplied from a first gas supply part and inflated and deployed in a traveling direction of a vehicle body; a second chamber that is disposed behind the first chamber and able to come in communication with an inside of the first chamber through a communication section; and a third chamber disposed to cover the communication section and configured to adjust an opening degree of the communication section by being filled with a gas supplied from a second gas supply part and being inflated and deployed.

(2) In the airbag device of the aspect of the above-mentioned (1), the communication section may include: a lid body configured to switch between a closed state in which an opening section of the communication section is covered and an open state in which the opening section of the communication section is opened; and a coupling member configured to connect the lid body and the third chamber, configured to hold the lid body in the closed state before the third chamber is inflated and deployed and configured to cause the lid body to be in the opened state as the third chamber is inflated and deployed.

(3) In the airbag device of the aspect of the above-mentioned (2), the lid body may be disposed with a first lid body and a second lid body overlapping each other in the closed state, the coupling member may be connected to the first lid body and the second lid body and may hold the lid body in the closed state, and the lid body may become to the opened state due to the coupling member being broken as the third chamber is inflated and deployed.

(4) In a control method of the airbag device of the aspect of any one of the above-mentioned (1) to (3), a control device of the airbag device may execute an object feature acquisition process of acquiring a feature of an object on the basis of information input from a detection part configured to detect the object; and an airbag device deploying process of adjusting operation patterns of the first gas supply part and the second gas supply part on the basis of the feature of the object acquired in the object feature acquisition process.

(5) In the control method of the airbag device of the aspect of the above-mentioned (4), the feature of the object may be a height of the object, and as the height of the object is greater, a timing of gas supply into the third chamber by the second gas supply part may be delayed further than a timing of gas supply of the first gas supply part.

(6) In the control method of the airbag device of the aspect of the above-mentioned (4), the feature of the object may be a height of the object, and when the height of the object is less than a prescribed value, the second gas supply part may start supply of a gas at a same timing as supply of the gas of the first gas supply part.

(7) In a control system of the airbag device of the aspect of any one of the above-mentioned (1) to (3), a control device of the airbag device may execute: an object feature acquisition process of acquiring a feature of an object on the basis of information input from a detection part configured to detect the object; and an airbag device deploying process of adjusting operation patterns of the first gas supply part and the second gas supply part on the basis of the feature of the object acquired in the object feature acquisition process.

According to the aspect of the above-mentioned (1), an opening degree of the communication section disposed to cover the first chamber and the second chamber is adjusted by the inflation and deployment of the third chamber. For this reason, for example, after the first chamber is filled with the gas from the first gas supply part and the first chamber is inflated and deployed, as the third chamber is filled with the gas from the second gas supply part, it is possible to open the communication section. Accordingly, since the gas flows into the second chamber from the first chamber, a time difference can be provided between the timings of the inflation and deployment of the first chamber and the inflation and deployment of the second chamber. Accordingly, it is possible to provide the airbag device that controls a deploying behavior of the airbag having the plurality of chambers and restraints a target person.

In addition, in the aspect of the above-mentioned (1), the first chamber and the second chamber are filled with the gas from the first gas supply part and inflated and deployed, and the third chamber is filled with the gas from the second gas supply part and inflated and deployed. For this reason, even when the gas supply part is not provided in the second chamber, the chambers can be filled with the gas and a structure of the airbag device can be simplified.

According to the aspect of the above-mentioned (2), since the lid body sets the opening section of the communication section in the closed state before the third chamber is inflated and deployed, first, only the first chamber can be filled with the gas. In addition, the time difference can be provided between the timing of inflation and deployment of the first chamber and the timing of inflation and deployment of the second chamber. The coupling member is broken as the third chamber is inflated and deployed. Accordingly, since the lid body is in the opened state in which the opening section of the communication section is opened, the gas can enter (fill) the second chamber through the communication section. The communication section includes the lid body and the coupling member. A gas pressure of the first chamber can be received integrally by the third chamber, the lid body, and the coupling member, and the opening due to the gas pressure by the first gas supply part can be suppressed. Accordingly, the inflation and deployment of each of the first chamber and the second chamber can be performed accurately and stepwise.

According to the aspect of the above-mentioned (3), the lid body is constituted by the first lid body and the second lid body. The lid body that constitutes the communication section is held in the closed state by the coupling member. In addition, the lid body becomes in the opened state due to the coupling member being broken as the third chamber is inflated and deployed. For this reason, the opened state and the closed state of the communication section can be controlled desirably by a breaking strength of the coupling member. In addition, since the closed state of the communication section is held by the plurality of lid bodies, pressure holding properties are increased.

According to the aspects of the above-mentioned (4) and (7), the operation patterns of the first gas supply part and the second gas supply part can be adjusted according to the feature of the object determined in the object determining process. Accordingly, inflation and deployment of each of the first chamber and the second chamber can be performed accurately and stepwise according to the feature of the object. In addition, restraint of the object can be performed accurately.

According to the aspect of the above-mentioned (5), since the timing of gas supply into the third chamber by the second gas supply part is delayed further than the timing of gas supply of the first gas supply part as the height of the object is greater, the inflation and deployment timing of the second chamber can be delayed further than the inflation and deployment timing of the first chamber. Accordingly, the object can be restrained by the second chamber while the pressure inside the first chamber is increased and controllability of a behavior of an object involved in a collision is improved. In addition, inflation and deployment of each of the chambers can be adjusted according to the height of the object.

According to the aspect of the above-mentioned (6), when it is determined that the feature of the object is less than the prescribed value, the combined volume of the first chamber and the second chamber is filled with the gas from the first gas supply part. For this reason, according to the Boyle's law, the pressure in the first chamber and the second chamber is smaller than when only the first chamber is filled with the same amount of gas. Accordingly, the object of which the feature is less than the prescribed value can be restrained with a gentle force.

### BRIEF DESCRIPTION OF THE DRAWINGS

FIG. 1 is an external perspective view of an airbag device according to an embodiment of the present invention.

FIG. 2 is a cross-sectional schematic view showing a deployed status of a first chamber according to the embodiment of the present invention.

FIG. 3 is a cross-sectional schematic view showing a deployed status of a second chamber and a third chamber according to the embodiment of the present invention.

FIG. 4 is a functional configuration view centered on an airbag control device.

FIG. 5 is a flowchart showing an example of a flow of processing performed by an airbag device control system.

FIG. 6 is a flowchart showing an example of an airbag device deploying step when it is determined that an object is a prescribed value or more.

FIG. 7 is a flowchart showing an example of the airbag device deploying step when it is determined that the object is less than the prescribed value.

FIG. 8 is a view showing an example of an aspect in which the airbag device is deployed when it is determined that the object is the prescribed value or more.

FIG. 9 is a view showing an example of an aspect in which the airbag device is deployed when it is determined that the object is less than the prescribed value.

### DETAILED DESCRIPTION OF THE INVENTION

Hereinafter, an embodiment of the present invention will be described with reference to the accompanying drawings. In the following description, directions of forward, rearward, leftward, rightward, upward and downward are the same as directions in a vehicle body. In addition, a leftward/rightward direction may be referred to as a vehicle width direction. In addition, a traveling direction of the vehicle body according to the embodiment is a forward direction.

### Embodiment

### [Airbag Device]

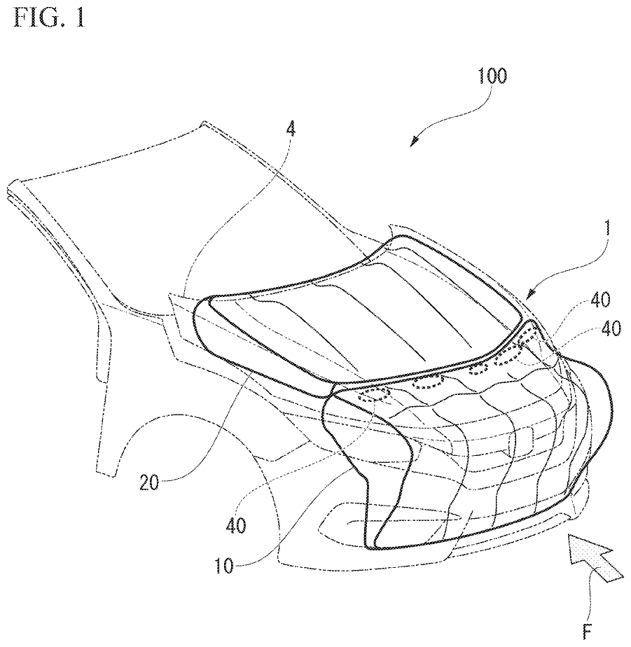

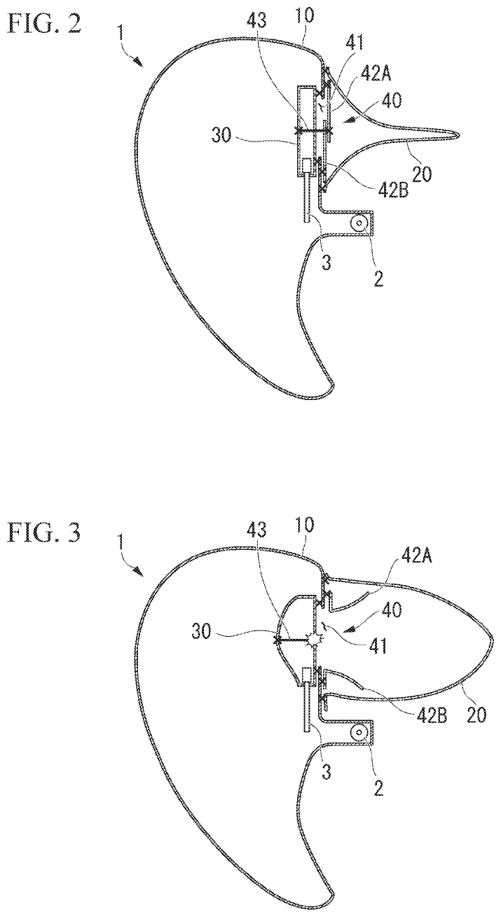

FIG. 1 is an external perspective view of an airbag device 1 according to an embodiment of the present invention. FIG. 2 is a cross-sectional schematic view showing a deployed status of a first chamber 10 according to the embodiment of the present invention. FIG. 3 is a cross-sectional schematic view showing a deployed status of a second chamber 20 and a third chamber 30 according to the embodiment of the present invention. A sign “x” shown in FIG. 2 and FIG. 3 is a coupling portion.

As shown in FIG. 1, the airbag device 1 is provided in a front section of a vehicle body 100.

The airbag device 1 includes the first chamber 10, the second chamber 20, the third chamber 30 (see FIG. 2), a first gas supply part 2 (see FIG. 2), a second gas supply part 3 (see FIG. 2), and a communication section 40.

The airbag device 1 is configured such that the plurality of chambers (the first chamber 10 and the second chamber 20) can be inflated and deployed forward. The airbag device 1 is disposed inside a hood 4, for example, in an engine room in a state before operation (before the plurality of chambers are inflated and deployed).

### <First Chamber>

The first chamber 10 is disposed at a position corresponding to a front end portion of the vehicle body 100. The first chamber 10 is formed in a bag shape by sewing, for example, a base fabric. The first chamber 10 is connected to the first gas supply part 2 configured to generate a high pressure gas. The first gas supply part 2 can use, for example, an inflator. The first chamber 10 is inflated and deployed in the forward direction that is the traveling direction of the vehicle body 100 by filling a gas from the first gas supply part 2. Specifically, the first chamber 10 swells from a gap or the like between the hood 4 in which the first chamber 10 is accommodated and a bumper to an outside of the vehicle. The first chamber 10 is disposed inside the hood 4 in a fold state before being inflated and deployed.

### <Second Chamber>

The second chamber 20 is disposed behind the first chamber 10. The second chamber 20 is formed in a bag shape by sewing the same base fabric as the first chamber 10. The second chamber 20 is connected to the first chamber 10 and formed integrally with the first chamber 10. The second chamber 20 comes into communication with the inside of the first chamber 10 through the communication section 40. Accordingly, a gas in the first chamber 10 flows into the second chamber 20 through the communication section 40. The plurality of communication sections 40 are provided at intervals, for example, in the vehicle width direction.

### <Communication Section>

The communication section 40 has an opening section 41, a lid body 42 and a coupling member 43.

The communication section 40 is provided throughout the first chamber 10 and the second chamber 20 in the forward/rearward direction. The communication section 40 is configured to bring the inside of the first chamber 10 and the inside of the second chamber 20 into communication with each other.

### <Third Chamber>

The third chamber 30 is disposed between the first chamber 10 and the second chamber 20 in the forward/rearward direction. In addition, the third chamber 30 is disposed in front of the second chamber 20. Specifically, the third chamber 30 is accommodated in the first chamber 10 and disposed to cover the communication section 40.

The third chamber 30 is formed in a bag shape by sewing the same base fabric as the first chamber 10. The second gas supply part 3 is provided in the third chamber 30. The second gas supply part 3 may have a configuration in which a gas is supplied into the third chamber 30. The second gas supply part 3 can use, for example, a micro gas generator (MGG).

The third chamber 30 may be temporarily sewn to the lid body 42 (see FIG. 2). The third chamber 30 may be attached to metal parts such as a retainer or the like, or may be internally sewn to the first chamber 10.

The third chamber 30 is inflated and deployed in the first chamber 10 in the traveling direction of the vehicle body 100 (toward the front outside the passenger compartment). The third chamber 30 is not inflated and deployed in a direction opposite to the traveling direction of the vehicle body (toward the communication section 40). In addition, a volume of the third chamber 30 upon inflation and deployment is smaller than the volume of the first chamber 10 upon inflation and deployment.

The first chamber 10, the second chamber 20 and the third chamber 30 formed in this way are inflated and deployed with time differences by the lid body 42 (see FIG. 2) and the coupling member 43 (see FIG. 2), which will be described in detail. Specifically, the first chamber 10, the third chamber 30 and the second chamber 20 are inflated and deployed in sequence. Accordingly, the airbag device 1 restraints a pedestrian in front of the vehicle body 100, an occupant on a two-wheeled vehicle, or the like (hereinafter referred to as a pedestrian or the like).

### <Opening Section>

The opening section 41 can bring the inside of the first chamber 10 and the inside of the second chamber 20 into communication with each other. Specifically, the opening section 41 is provided in a connecting portion between the first chamber 10 and the second chamber 20. The opening section 41 is provided on the side of the first chamber 10. In this case, the second chamber 20 is connected to the first chamber 10 to surround the opening section 41 as a whole. While the opening section 41 is provided on the side of the first chamber 10 in the embodiment, the opening section 41 may be provided on the side of the second chamber 20. In this case, the first chamber is connected to the second chamber 20 to surround the opening section 41 as a whole.

### <Lid By (First Lid Body, Second Lid Body)>

As shown in FIG. 2 and FIG. 3, the lid body 42 covers the opening section 41 to be opened and closed. The lid body 42 is constituted by a first lid body 42A and a second lid body 42B. The lid body 42 covers the opening section 41 as a whole in a state before the third chamber 30 is inflated and deployed (a state shown in FIG. 2). The state in which the lid body 42 covers the opening section 41 as a whole is referred to as “a closed state (of the lid body 42).” Accordingly, an inflow of a gas from the first chamber 10 to the second chamber 20 is suppressed by holding a closed state of the lid body 42.

The lid body 42 opens the opening section 41 in a state in which the third chamber 30 is inflated and deployed (a state shown in FIG. 3). The state in which the lid body 42 opens the opening section 41 is referred to as “an open state (of the lid body 42).” Accordingly, when the lid body 42 is in the open state, the gas flows into the second chamber 20 from the first chamber 10.

### <Coupling Member>

The coupling member 43 connects the third chamber 30 and the lid body 42. Specifically, the coupling member 43 connects the third chamber 30 and the lid body 42 in a thickness direction upon inflation and deployment of the third chamber 30. One end of the coupling member 43 is connected to the third chamber 30, and the other end of the coupling member 43 is connected to the lid body 42. More specifically, the coupling member 43 is connected to a portion in which the first lid body 42A and the second lid body 42B overlap each other.

The coupling member 43 is configured to be cut. A length of the coupling member 43 is set to a length cut in a state in which the third chamber 30 is inflated and deployed (a state shown in FIG. 3). Specifically, a length dimension of the coupling member 43 in the forward/rearward direction is smaller than a thickness of the third chamber 30 inflated and deployed in the forward/rearward direction. When the third chamber 30 is inflated and deployed, the third chamber 30 is inflated and deployed in the traveling direction of the vehicle body 100. Then, in the coupling member 43, the connecting portion with the third chamber 30 is pulled and cut. The coupling member 43 may be cut by a cutter.

The coupling member 43 holds the lid body 42 in a closed state before the third chamber 30 is inflated and deployed (a state shown in FIG. 2).

The coupling member 43 is cut as the third chamber 30 is inflated and deployed. For this reason, the coupling member 43 can cause the lid body 42 to be in an open state while the third chamber 30 is inflated and deployed (a state shown in FIG. 3).

### [Operation of Airbag Device]

An operation of the above-mentioned airbag device 1 will be described.

The airbag device 1 is inflated and deployed toward a side in front of the vehicle body 100 and restraints an object.

First, after the first chamber 10 is inflated and deployed, the operation of the airbag device 1 when the second chamber 20 is inflated and deployed will be described.

When a predetermined condition is satisfied, a gas is supplied (injected) from the first gas supply part 2. When the gas is injected from the first gas supply part 2, as shown in FIG. 2, the first chamber 10 starts to be inflated and deployed. The first chamber 10 is inflated and deployed in the forward direction that is the traveling direction of the vehicle body 100.

Here, since the closed state of the lid body 42 is held by the coupling member 43, inflation and deployment of the second chamber 20 are suppressed.

After the first chamber 10 is filled with the gas from the first gas supply part 2 and the first chamber 10 is inflated and deployed, the third chamber 30 is filled with the gas from the second gas supply part 3. When the third chamber 30 is inflated and deployed, the coupling member 43 connected to the third chamber 30 is pulled. The coupling member 43 is cut when it reaches a predetermined tension.

When the coupling member 43 is cut, the lid body 42 is in an open state. Accordingly, the gas with which the first chamber 10 is filled flows into the second chamber 20 through the opening section 41 of the communication section 40. Then, as shown in FIG. 3, the second chamber 20 is inflated and deployed.

In this way, the first chamber 10 and the second chamber 20 are inflated and deployed at a time difference in sequence.

Next, an operation of the airbag device 1 when the first chamber 10 and the second chamber 20 are inflated and deployed at the same time will be described.

When the predetermined condition is satisfied, the gas is supplied [injected] from the first gas supply part 2 and the second gas supply part 3. When the gas is injected from the first gas supply part 2, the first chamber 10 starts to be inflated and deployed. The first chamber 10 is inflated and deployed in the traveling direction of the vehicle body 100.

The second gas supply part 3 starts injection of the gas at the same timing as supply (injection) of the gas by the first gas supply part 2. The third chamber 30 starts to be inflated and deployed at the same timing as start of inflation and deployment of the first chamber 10.

When the third chamber 30 is inflated and deployed, the coupling member 43 is cut, and the lid body 42 is in an open state. Accordingly, the gas with which the first chamber 10 is filled flows into the second chamber 20 through the opening section 41 of the communication section 40. Then, as shown in FIG. 3, the second chamber 20 is inflated and deployed. In this way, the first chamber 10 and the second chamber 20 are inflated and deployed with no time difference (at the same timing).

### [Control Method of Airbag Device]

Hereinafter, a control method of the airbag device 1 will be described.

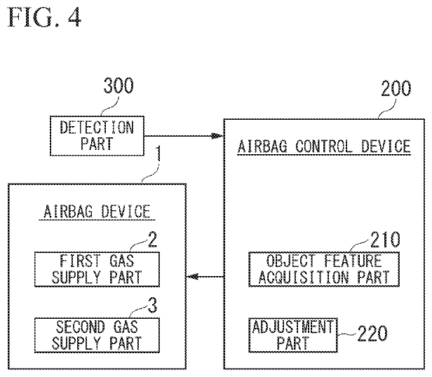

FIG. 4 is a functional configuration view centered on an airbag control device 200.

A detection part 300 shown in FIG. 4 is a combination of, for example, a camera and an image analysis device. Instead of this, the detection part 300 may be a radar device or may be light detection and ranging (LIDAR). The detection part 300 may incorporate those used for control such as an advanced driver assistance system (ADAS) or the like. The image analysis device analyzes an image captured by the camera and extracts a height of a substance in front of the vehicle.

The airbag control device 200 includes, for example, an object feature acquisition part 210 and an adjustment part 220. These components are configured to cause a hardware processor such as a central processing unit (CPU) or the like to execute a program (software). A part or the entirety of the airbag control device 200 may be realized by hardware (a circuit part; including circuitry) such as large scale integration (LSI), an application specific integrated circuit (ASIC), a field-programmable gate array (FPGA), a graphics processing unit (GPU), or the like, or may be realized by cooperation of software and hardware. The program may be stored in a storage device such as a hard disk drive (HDD), a flash memory, or the like (a storage device including a non-transient storage medium) in advance, may be stored in a detachable storage medium (a non-transient storage medium) such as a DVD, a CD-ROM, or the like, or may be installed in a storage device by mounting the storage medium in a drive device.

The object feature acquisition part 210 acquires features of the object on the basis of the information input from the detection part 300. For example, the object feature acquisition part 210 acquires whether the object is a person and his/her height as features of the object on the basis of a region occupied by the object in the image acquired by the camera.

Further, such a function may be provided in the detection part 300. In this case, the object feature acquisition part 210 simply acquires information related to the features of the object from the detection part 300.

The adjustment part 220 adjusts operation patterns of the first gas supply part 2 and the second gas supply part 3 on the basis of the features of the object acquired by the object feature acquisition part 210. Specifically, the adjustment part 220 adjusts a pattern of gas filling by the first gas supply part 2 and the second gas supply part 3 that are described above.

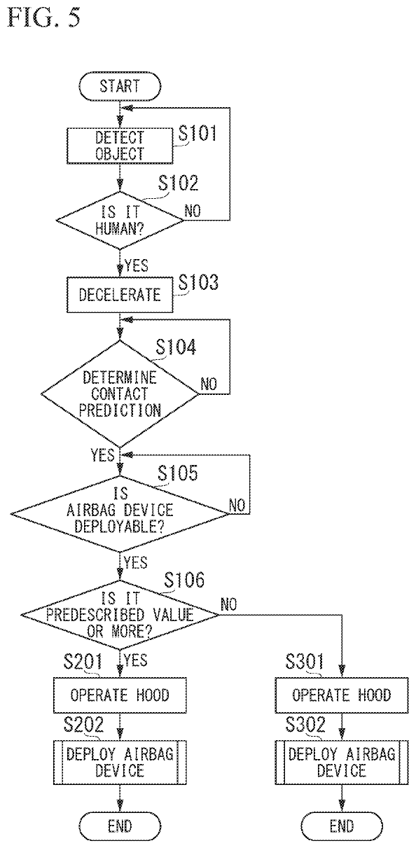

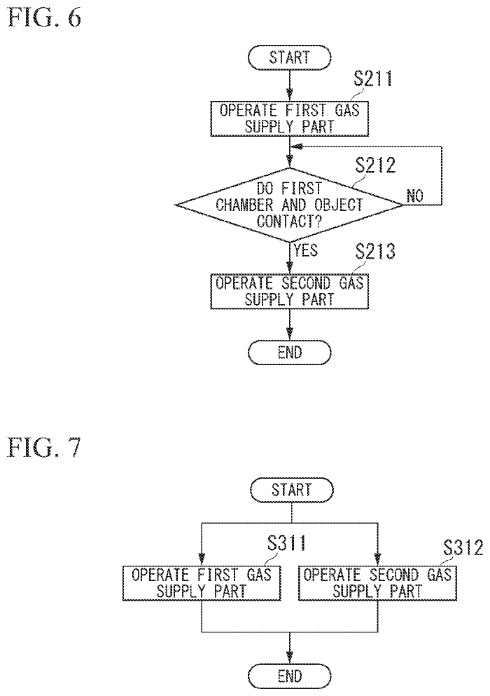

FIG. 5 is a flowchart showing an example of a flow of processing performed by the airbag control device 200. FIG. 6 is a flowchart showing an example of an airbag device deploying step (step a S202) when it is detected that the object is a prescribed value or more. FIG. 7 is a flowchart showing an example of an airbag device deploying step (step S302) when it is determined that the object is less than the prescribed value.

Further, in the following description, “a human” includes a pedestrian, a driver on bicycle or a saddle riding vehicle including a motorcycle person (hereinafter, referred to as “a cyclist”).

A control method of the airbag device includes an object determining process and an airbag device deploying process.

### <Object Determining Process>

The object determining process includes an object detecting step (step S101), a step of determining whether the object is a human (step S102), a deceleration control step of the vehicle body 100 (step S103), a step of determining whether the airbag device 1 is deployable (step S105), and a step of determining features of the object (step S106).

First, the detection part 300 detects the object disposed in the traveling direction of the vehicle body 100 (step S101). Next, the detection part 300 determines whether the detected object is a human (step S102).

When the object is a human, the vehicle body 100 is controlled to be decelerated (step S103). The detection part 300 predicts, for example, a timing when the object contacts (collides) with the vehicle body 100 on the basis of the moving direction of the object (human) and the traveling direction of the vehicle body 100 (step S104).

In step S105, when it is determined that the airbag device 1 is deployable, the object feature acquisition part 210 determines whether the height of the object is a prescribed value or more (step S106). That is, the object feature acquisition part 210 determines whether the object is the prescribed value or more. Specifically, as the prescribed values, the height of the object from the ground to a head apex section is preferably 150 cm, more preferably 145 cm, or further preferably 140 cm. Further, the object feature acquisition part 210 may be provided in the same control unit as the detection part 300.

### <Airbag Device Deploying Process>

The airbag device deploying process has a hood operating step (steps S201 and S301) and an airbag device deploying step (steps S202 and S302).

In the hood operating step (steps S201 and S301), a pop-up hood (PUH) may be used.

In the airbag device deploying process, the case in which it is determined in step S106 that the object is the prescribed value or more and the case in which it is determined in step S106 that the object is less than the prescribed value will be described separately.

<When it is Determined that Object is Prescribed Value or More>

When it is determined in step S106 that the object is the prescribed value or more, first, the hood 4 is operated, and the airbag device 1 disposed inside the hood 4 can be deployed outside the vehicle (step S201).

### <Step S202>

Next, the airbag device 1 is deployed (step S202).

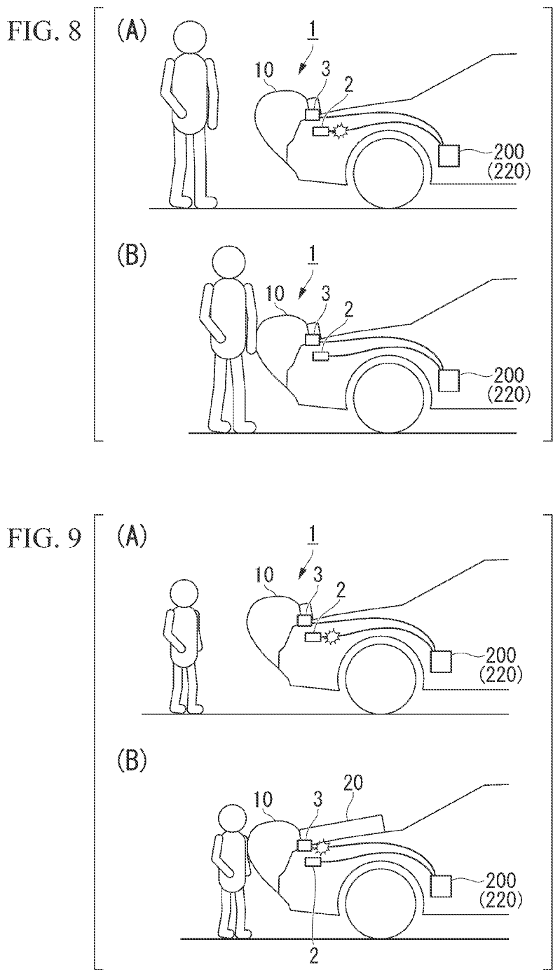

FIG. 8 is a view showing an example of an aspect in which the airbag device 1 is deployed when it is determined that the object is the prescribed value or more.

When the predetermined signal is input to the adjustment part 220 provided in the vehicle body 100, the first gas supply part 2 is operated (step S211). When the first gas supply part 2 is operated, the gas is supplied (injected) from the first gas supply part 2, and the first chamber 10 is inflated and deployed. The first chamber 10 is inflated and deployed toward a side in front of the vehicle body 100 in the traveling direction. The adjustment part 220 determines whether the object contacts (collides) with the first chamber 10 that was inflated and deployed (step S212). When it is determined that the object and the inflated and deployed first chamber 10 are in contact with each other, the adjustment part 220 operates the second gas supply part 3 (step S213). When the second gas supply part 3 is operated, the third chamber 30 is filled with the gas from the second gas supply part 3.

When the third chamber 30 is inflated and deployed, the coupling member 43 connected to the third chamber 30 is pulled. The coupling member 43 is cut when it reaches a predetermined tension. When the coupling member 43 is cut, the gas with which the first chamber 10 is filled flows into the second chamber 20.

According to the configuration, as shown in FIG. 8(B), the object is restrained by the first chamber 10. Then, the second chamber 20 is inflated and deployed (see FIG. 3). The head section of the object is restrained by the inflated and deployed second chamber 20. When it is determined that the object is the prescribed value or more, a deployment timing of the second chamber 20 is further delayed. Accordingly, the object can be restrained by the second chamber 20 while the pressure in the first chamber 10 is increased and controllability of a behavior of the collided object is improved.

Further, the timing of inflation and deployment of the chambers is not limited to the configuration as long as the object determined as being the prescribed value or more can be restrained. The timing of inflation and deployment of the chambers may be stepwise or may be continuous.

<When it is Determined that Object is Less than Prescribed Value>

Returning to FIG. 5, when it is determined in step S106 that the object is less than the prescribed value, first, the hood 4 is operated, and the airbag device 1 disposed inside the hood 4 can be deployed outside the vehicle (step S301).

### <Step S302>

Next, the airbag device 1 is deployed (step S302).

FIG. 9 is a view showing an example of an aspect in which the airbag device is deployed when it is determined that the object is less than the prescribed value.

When the predetermined signal is input to the adjustment part 220 provided on the vehicle body 100, the first gas supply part 2 and the second gas supply part 3 are operated (steps S311 and S312), and the gas is supplied (injected) from the first gas supply part 2 and the second gas supply part 3. When the gas is injected from the first gas supply part 2 (step S311), the first chamber 10 starts to be inflated and deployed. The first chamber 10 is inflated and deployed in the traveling direction of the vehicle body 100.

The second gas supply part 3 starts injection of the gas at the same timing as supply (injection) of the gas of the first gas supply part 2 (step S312). The third chamber 30 starts to be inflated and deployed at the same timing as starting of inflation and deployment of the first chamber 10.

When the third chamber 30 is inflated and deployed, the coupling member 43 is cut and the gas with which the first chamber 10 is filled flows into the second chamber 20. Then, the second chamber 20 is inflated and deployed. Accordingly, the first chamber 10 and the second chamber 20 are inflated and deployed with no time difference (at the same timing).

According to the configuration, as shown in FIG. 9(B), the combined volume of the first chamber 10 and the second chamber 20 is filled with the gas from the first gas supply part 2. For this reason, according to Boyle's law, the pressure in the first chamber 10 and the second chamber 20 is smaller than when only the first chamber 10 is filled with the same amount of gas. Accordingly, the object that is less than the prescribed value can be restrained with a gentle force.

### [Actions and Effects]

Actions and effects of the above-mentioned airbag will be described.

According to the airbag device 1 of the embodiment, an opening degree of the communication section 40 disposed to cover the first chamber 10 and the second chamber 20 is adjusted by inflation and deployment of the third chamber 30. For this reason, for example, after the first chamber 10 is filled with the gas from the first gas supply part 2 and the first chamber 10 is inflated and deployed, the third chamber 30 is filled with the gas from the second gas supply part 3, and thus, the communication section 40 can be opened. Accordingly, since the gas flows into the second chamber 20 from the first chamber 10, a time difference can be provided between the timings of the inflation and deployment of the first chamber 10 and inflation and deployment of the second chamber 20. Accordingly, it is possible to control a deploying behavior of the airbag having a plurality of chambers and provide the airbag device 1 that restraints an object person.

In addition, in the airbag device 1 of the embodiment, the first chamber 10 and the second chamber 20 are filled with the gas from the first gas supply part 2 and inflated and deployed, and the third chamber 30 is filled with the gas from the second gas supply part 3 and inflated and deployed. For this reason, even when the gas supply part is not provided in the second chamber 20, the chambers can be filled with the gas, and manufacture of the airbag device 1 can be simplified.

According to the airbag device 1 of the embodiment, since the lid body 42 sets the opening section 41 of the communication section 40 to the closed state in a state before the third chamber 30 is inflated and deployed, first, only the first chamber 10 can be filled with the gas. In addition, a time difference can be provided between timing of inflation and deployment of the first chamber 10 and timing of inflation and deployment of the second chamber 20. The coupling member 43 is broken as the third chamber 30 is inflated and deployed. Accordingly, since the lid body 42 is in an open state in which the opening section 41 of the communication section 40 is open, the gas can flow into (be filled in) the second chamber 20 through the communication section 40. The communication section 40 includes the opening section 41, the lid body 42 and the coupling member 43. A gas pressure of the first chamber 10 can be received integrally by the third chamber 30, the lid body 42 and the coupling member 43, and the opening due to the gas pressure by the first gas supply part 2 can be suppressed. Accordingly, inflation and deployment of each of the first chamber 10 and the second chamber 20 can be performed accurately and stepwisely.

According to the airbag device 1 of the embodiment, the lid body 42 is constituted by the first lid body 42A and the second lid body 42B. The lid body 42 that constitutes the communication section 40 is held in the closed state by the coupling member 43. In addition, the lid body 42 is in the open state as the coupling member 43 is broken due to inflation and deployment of the third chamber 30. For this reason, it is possible to desirably control the open state and the closed state of the communication section 40 according to the braking strength of the coupling member 43. In addition, since the closed state of the communication section 40 is held by the plurality of lid bodies (the first lid body 42A and the second lid body 42B), pressure-holding properties can be increased.

According to the control method and the control system of the airbag device 1 of the embodiment, operation patterns of the first gas supply part 2 and the second gas supply part 3 can be adjusted according to features of the object determined by the object determining process. Accordingly, inflation and deployment of each of the first chamber 10 and the second chamber 20 can be performed accurately and stepwisely according to the features of the object. In addition, restraint of the object can be performed accurately.

According to the control method of the airbag device 1 of the embodiment, when it is determined that the object is the prescribed value or more, the inflation and deployment timing of the second chamber 20 is further delayed than the inflation and deployment timing of the first chamber 10. Accordingly, the object can be restrained by the second chamber while the pressure in the first chamber 10 is increased and controllability of a behavior of the collided object is improved.

According to the control method of the airbag device 1 of the embodiment, when it is determined that the object is less than the prescribed value, the combined volume of the first chamber 10 and the second chamber 20 is filled with the gas from the first gas supply part 2. For this reason, according to the Boyle's law, the pressure in the first chamber 10 and the second chamber 20 is smaller than when the first chamber 10 only is filled with the same amount of gas. Accordingly, the object that is less than the prescribed value can be restrained with a gentle force.

### [Variant]

Further, the technical range of the present invention is not limited to the above-mentioned embodiment, and various modifications may be added without departing from the scope of the present invention.

While the configuration in which the lid body 42 covers the communication section 40 as a whole in a state before the third chamber 30 is inflated and deployed (the state shown in FIG. 2) has been described in the embodiment, there is no limitation thereto. The lid body 42 may cover a part of the communication section 40 in a state before the third chamber 30 is inflated and deployed.

While the configuration in which the third chamber 30 covers the communication section 40 as a whole has been described in the embodiment, at least a part thereof may be covered

While the configuration in which the third chamber 30 and the lid body 42 are provided separately has been described in the embodiment, the third chamber 30 may function as the lid body 42.

The airbag device 1 may be provided in, for example, a luggage space in a rear section of the vehicle body 100. Further, in this case, a rear side corresponds to the traveling direction of the vehicle body 100.

In the airbag device 1, the first chamber 10 and the second chamber 20 may be inflated and deployed toward the inside of the passenger compartment. In this case, the occupant can be restrained by the airbag device 1.

In the airbag device 1, a lid may be provided on a part of a bumper, and the lid may open and inflate and deploy the first chamber 10 and the second chamber 20. At this time, the operation of the hood 4 described in the flowchart is not necessary.

In addition, in deployment of the airbag device 1 when it is determined that the object is less than the prescribed value, while the first gas supply part 2 and the second gas supply part 3 are simultaneously operated in step S302, an operation start timing of the second gas supply part 3 may be after the operation of the first gas supply part 2 as long as it is earlier than an operation timing of the second gas supply part 3 when it is determined that the object is the prescribed value or more.

While the configuration in which the prescribed value is set to a predetermined numerical value has been described in the embodiment, the prescribed value may be set within a numerical range. A lower limit value of the numerical range of the prescribed value is preferably 110 cm or more, more preferably 115 cm or more, or further preferably 120 cm or more. An upper limit value of the numerical range of the prescribed value is preferably 150 cm or less, more preferably 145 cm or less, or further preferably 140 cm or less. In addition, a range of the prescribed value can be arbitrarily set to the numerical value. When the prescribed value is set within the numerical range, it is determined whether a height of the object is equal to or greater than the upper limit value of the prescribed value (step S106). The object that is equal to or greater than the upper limit value of the prescribed value is restrained in a step when “it is determined that the object is the prescribed value or more.” The object that is equal to or greater than the lower limit value of prescribed value and smaller than the upper limit value is restrained in a step when “it is determined that the object is less than the prescribed value.”

In the embodiment, when it is determined that the height of the object is equal to or greater than the prescribed value, the second gas supply part 3 has a configuration in which a timing of gas supply into the third chamber 30 is delayed further than a timing of gas supply of the first gas supply part 2. On the other hand, according to the height of the object, the second gas supply part 3 may have a configuration in which a timing of gas supply into the third chamber 30 is delayed further than a timing of gas supply into the first gas supply part 2. In addition, a difference between the timing of gas supply of the first gas supply part 2 and the timing of gas supply of the second gas supply part 3 may be stepwise or continuous according to the height of the object.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

What is claimed is:

1. An airbag device comprising:
a first chamber filled with a gas supplied from a first gas supply part and inflated and deployed in a traveling direction of a vehicle body;
a second chamber that is disposed behind the first chamber and able to come in communication with an inside of the first chamber through a communication section; and
a third chamber disposed to cover the communication section and configured to adjust an opening degree of the communication section by being filled with a gas supplied from a second gas supply part and being inflated and deployed.

2. The airbag device according to claim 1, wherein the communication section comprises:
a lid body configured to switch between a closed state in which an opening section of the communication section is covered and an open state in which the opening section of the communication section is opened; and
a coupling member configured to connect the lid body and the third chamber, configured to hold the lid body in the closed state before the third chamber is inflated and deployed and configured to cause the lid body to be in the opened state as the third chamber is inflated and deployed.

3. The airbag device according to claim 2, wherein the lid body is disposed with a first lid body and a second lid body overlapping each other in the closed state,
the coupling member is connected to the first lid body and the second lid body and holds the lid body in the closed state, and
the lid body becomes to the opened state due to the coupling member being broken as the third chamber is inflated and deployed.

4. A control method of the airbag device according to claim 1, the control method executed by a control device of the airbag device, comprising:
an object feature acquisition process of acquiring a feature of an object on the basis of information input from a detection part configured to detect the object; and
an airbag device deploying process of adjusting operation patterns of the first gas supply part and the second gas supply part on the basis of the feature of the object acquired in the object feature acquisition process.

5. The control method of the airbag device according to claim 4, wherein the feature of the object is a height of the object, and
as the height of the object is greater,
a timing of gas supply into the third chamber by the second gas supply part is delayed further than a timing of gas supply of the first gas supply part.

6. The control method of the airbag device according to claim 4, wherein the feature of the object is a height of the object, and
when the height of the object is less than a prescribed value,
the second gas supply part starts supply of a gas at a same timing as supply of the gas of the first gas supply part.

7. A control system of the airbag device according to claim 1, wherein a control device of the airbag device executes:
an object feature acquisition process of acquiring a feature of an object on the basis of information input from a detection part configured to detect the object; and
an airbag device deploying process of adjusting operation patterns of the first gas supply part and the second gas supply part on the basis of the feature of the object acquired in the object feature acquisition process.
